(19) United States
(12) Patent Application Publication
(10) Pub. No.: US 2015/0203136 A1
(43) Pub. Date: Jul. 23, 2015

(54) FOLDABLE LUGGAGE CARRIER

(71) Applicants: Wen-Fa Wang, Taichung City (TW); Jian-Wen Deng, Yangjiang City (CN)

(72) Inventors: Wen-Fa Wang, Taichung City (TW); Jian-Wen Deng, Yangjiang City (CN)

(21) Appl. No.: 14/159,388

(22) Filed: Jan. 20, 2014

(51) Int. Cl. B62B 1/04; B62B 1/02

(52) U.S. Cl. CPC B62B 1/045; B62B 1/02

(57) ABSTRACT

A foldable luggage carrier includes a frame, a supporting tray and a pair of wheeled carriages. The tray has a pair of pivot brackets pivotally connected to two leg portions of the frame such that the tray is pivotable between a forwardly extended position and a fold-up position. Each of the pivot brackets includes a pair of opposed plates and a cam portion at a corner. Each of the wheeled carriages includes a wheel bracket having a sleeve bearing rotatably supported on the leg portions of the frame to permit the wheeled carriages to pivot between rearwardly extended positions and folded-in positions. The sleeve bearing has a guiding slope section at a bottom to interact with each cam portion of the pivot bracket in a manner such that the wheeled carriages automatically pivot to the folded-in positions and the rearwardly extended positions when the tray is moved between the fold-up position and the forwardly extended position.

### BACKGROUND OF THE INVENTION

1. Field of the Invention

This invention relates in general to luggage carriers and in particular to luggage carriers equipped with inwardly collapsible tray and wheeled carriages.

2. Description of the Related Art

In recent years, luggage carriers have undergone a developmental transformation for the long distances travelers must walk in airports carrying their luggage. Numerous luggage carriers have been adapted to be portable and include built-in collapsible features. While such collapsible carriers have enjoyed increasing popularity, the majority appear to suffer from several common disadvantages. They are generally equipped with complicated components making them awkward to collapse and not easy to transport in the collapsed position.

It would therefore be a distinct advance in the art of collapsible luggage carriers to provide such a device using less components and having good structural stability, and which is quickly and easily collapsible into a substantially flat neat package.

### SUMMARY OF THE INVENTION

One object of the present invention is to provide a collapsible luggage carrier that is compact and of small size when collapsed so that it can be easily and conveniently transported and stored when not in use while at the same time is strong and stable.

Another object is to provide a luggage carrier that is easy to collapse for transport and storage and to extend for use. Still another object is to provide a collapsible luggage carrier with the aforementioned attributes and advantages that can be mass-produced with less components at relatively low cost and good structural stability.

The foregoing and other objects and advantages are attained, according to the present invention, by a collapsible luggage carrier comprising a frame, a supporting tray and a pair of transversely spaced-apart wheeled carriages. The frame has an upper handle portion and a pair of lower leg portions configured to provide support for an article in a first plane. The supporting tray has a pair of pivot brackets and two pivot pins. The pivot brackets receives the pivot pins which transversely extending through lower ends of the leg portions of the frame such that the tray is pivotable between a forwardly extended position in which the tray is disposed substantially orthogonally to the first plane, and a fold-up position in which the tray is disposed substantially parallel with the first plane. In particular, each of the pivot brackets includes a pair of opposed plates and at least one cam portion projecting from a corner of one of the opposed plates.

Each of the wheeled carriages includes a wheel bracket and a wheel. Each of the wheel brackets has two opposed projecting arms to embrace the wheel and a sleeve bearing rotatably supported on each leg portion of the frame to permit the wheeled carriages to pivot between rearwardly extended positions where the axes of rotation of the wheels are in parallel relation to the first plane, and folded-in positions where the axes of rotation of the wheels are disposed orthogonally to the first plane. Particularly, the sleeve bearing is formed at an annular bottom surface with a guiding slope section and a generally flat section which together define an obtuse angle therebetween.

In such a manner, when the tray is disposed in the forwardly extended position, the cam portion of each pivot bracket is rested with one side in between the guiding slope section and the flat section of the respective sleeve bearing. While the tray is moved from the forwardly extended position to the fold-up position, the cam portion swings about the pivot pin and bears against the guiding slope section of the sleeve bearing, resulting in each wheeled carriage pivoting from the rearwardly extended position to the folded-in position.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a foldable luggage carrier in accordance with the preferred embodiment of the present invention;

FIG. 2 is an exploded perspective view of the luggage carrier shown in FIG. 1;

FIG. 3 is an enlarged perspective view of a wheel bracket of the luggage carrier with a spring inserted in a sleeve bearing of the wheel bracket;

FIG. 4 is an enlarged perspective view of the spring shown in FIG. 3;

FIG. 5 is another perspective view of the wheel bracket of the luggage carrier, from another angle; and

FIGS. 6-8 are side elevational views illustrating the process of folding up the luggage carrier for storage.

### DETAILED DESCRIPTION OF EMBODIMENTS

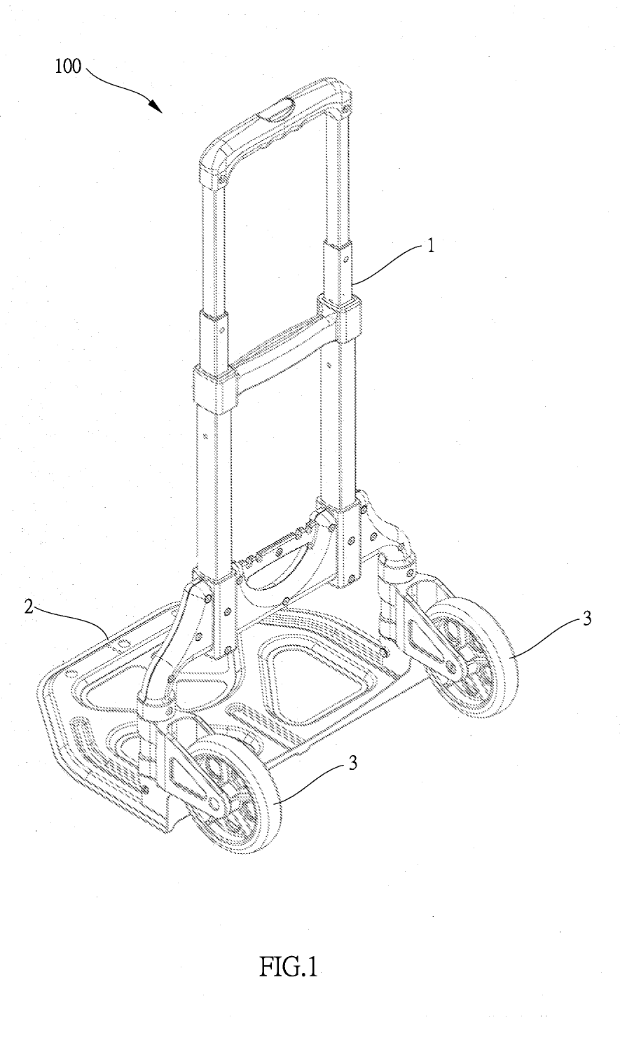

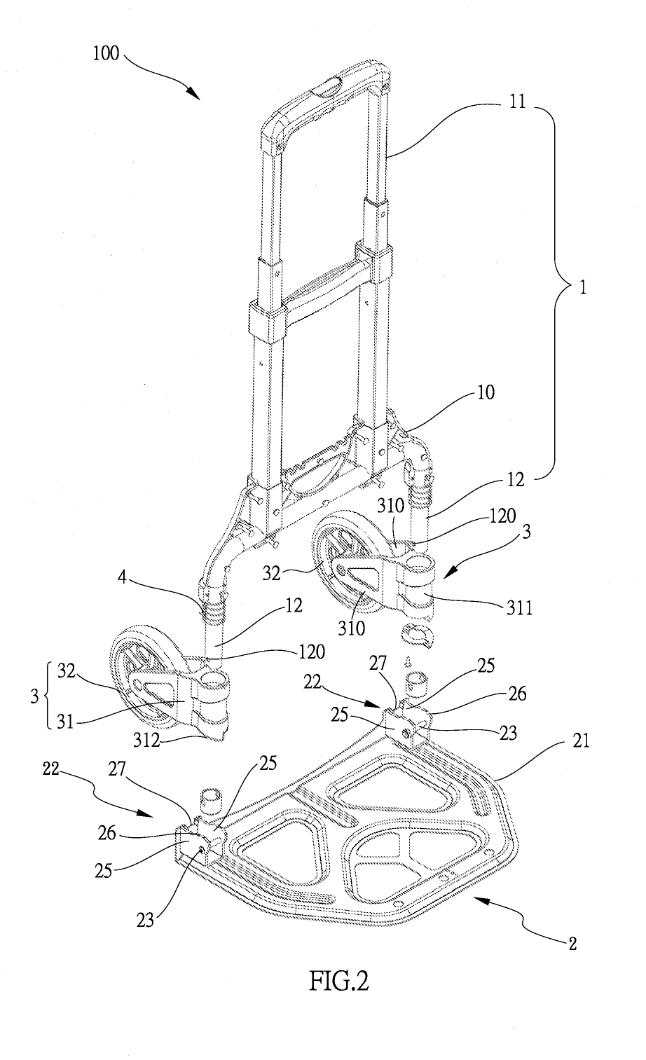

Turning now descriptively to the drawings, FIGS. 1 and 2 illustrate a foldable luggage carrier 100 consisting generally of a frame 1, a supporting tray 2 and a pair of transversely spaced-apart wheeled carriages 3.

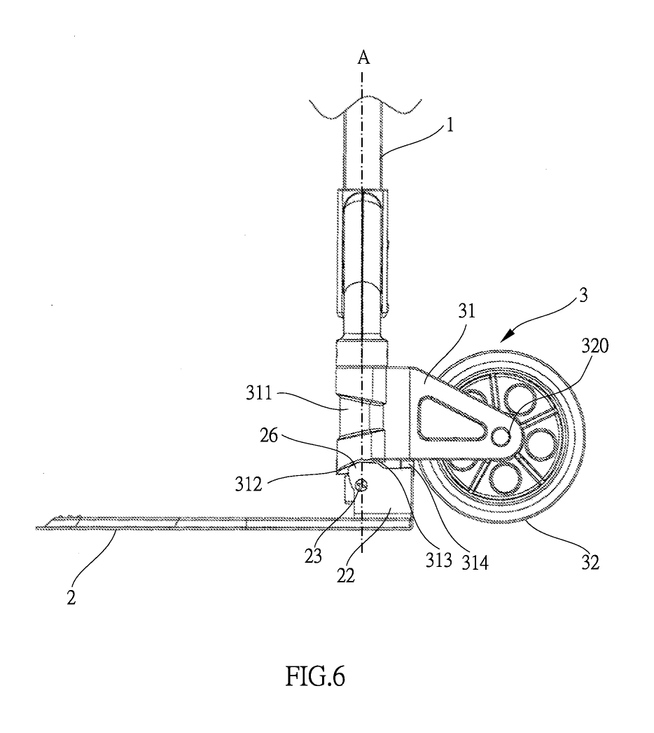

As shown in FIG. 2, the frame 1 includes a body 10, a handle portion 11 extending from a top of the body 10 and a pair of lower leg portions 12 extending from a bottom of the body 10. The upper handle portion 11 is of conventional design to provide a generally U-shaped telescoping handle. The lower leg portions 12 are configured to provide support for an article in a first plane A (see FIG. 6).

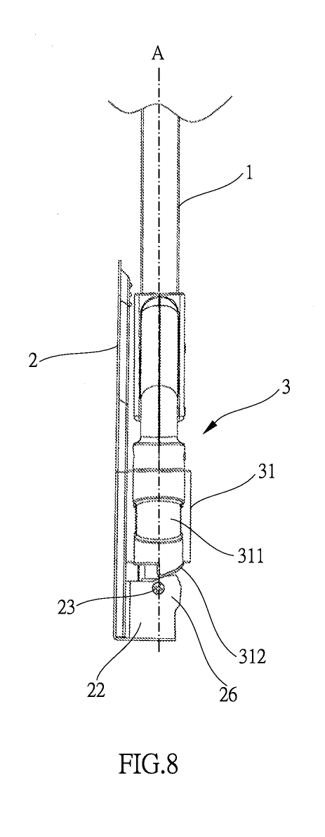

The supporting tray 2 (hereinafter tray) includes a base member 21, a pair of pivot brackets 22 secured on an edge of the base member 21 and two pivot pins 23. The pivot brackets 22 are pivotally connected to the leg portions 12 of the frame 1 by means of the pivot pins 23 which transversely extend through the holes 120 in the lower ends of the leg portions 12. In this manner, the tray 2 is pivotable between a forwardly extended position (FIG. 6) where the tray 2 is disposed substantially orthogonally to the first plane A, and a fold-up position (FIG. 8) where the tray 2 is disposed substantially parallel with the first plane A. Moreover, each of the pivot brackets 22 includes a pair of opposed plates 25 and at least one cam portion 26 projecting from a corner of one of the opposed plates 25, as will be discussed in detail later.

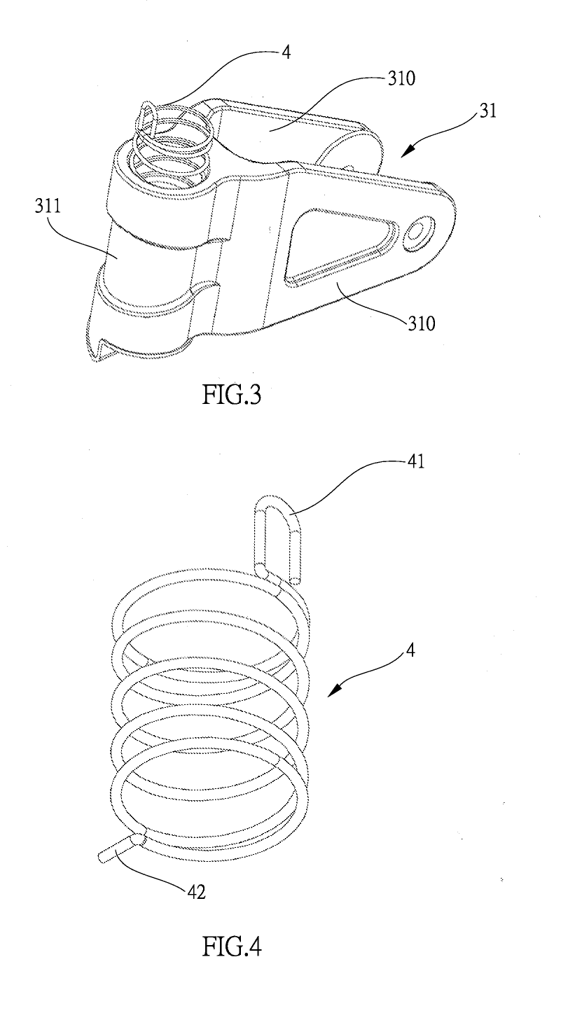

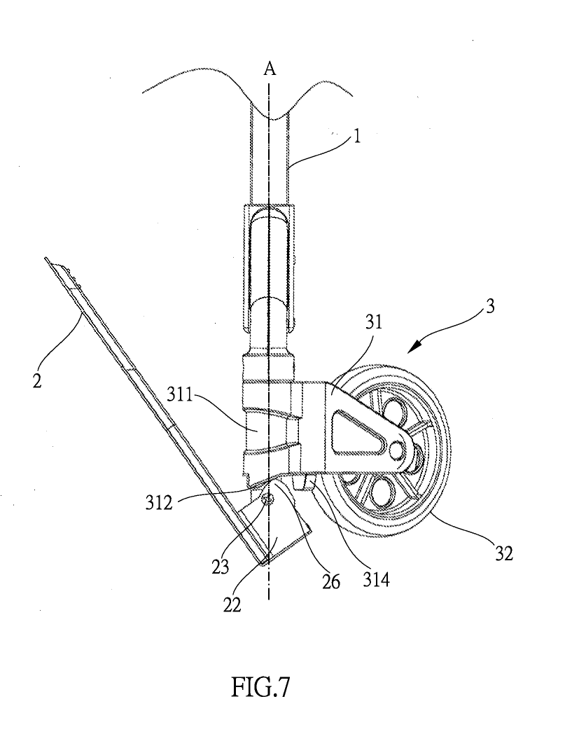

Referring to FIG. 2 again, each of the wheeled carriages 3 has a wheel bracket 31 and a wheel 32 received in the wheel bracket 31. As best seen in FIG. 3, each of the wheel brackets 31 includes two opposed projecting arms 310 at one side and a sleeve bearing 311 at the other side. The arms 310 embrace the wheel 32 therebetween. The sleeve bearing 311 of the wheel bracket 31 is rotatably supported on each leg portion 12 of the frame 1, as illustrated in FIGS. 6-8, to permit the wheeled carriages 3 to pivot between rearwardly extended positions, as shown in FIG. 6, where the axes 320 of rotation of the wheels 32 are in parallel relation to the first plane A, and folded-in positions, as shown in FIG. 8, in which the axes 320 of rotation of the wheels 31 are disposed orthogonally to the first plane A. In particular, as best seen in FIG. 5, the sleeve bearing 311 is formed at its annular bottom surface with a guiding slope section 312 and a generally flat section 313 which together define an obtuse angle (not numbered) therebetween to interact with the cam portion 26 of each pivot bracket 22.

More specifically, referring to FIG. 6, when the tray 2 is disposed in the forwardly extended position, the cam portion 26 of each pivot bracket 22 is rested with one side in between the guiding slope section 312 and the flat section 313 of the respective sleeve bearing 311. However, while the tray 2 is moved from the forwardly extended position to the fold-up position, as illustrated in FIGS. 6-8, the cam portion 26 swings about the pivot pin 23 and bears against the guiding slope section 312 of the sleeve bearing 311, resulting in each wheeled carriage 3 pivoting from the rearwardly extended position (FIG. 6) to the folded-in position (FIG. 8).

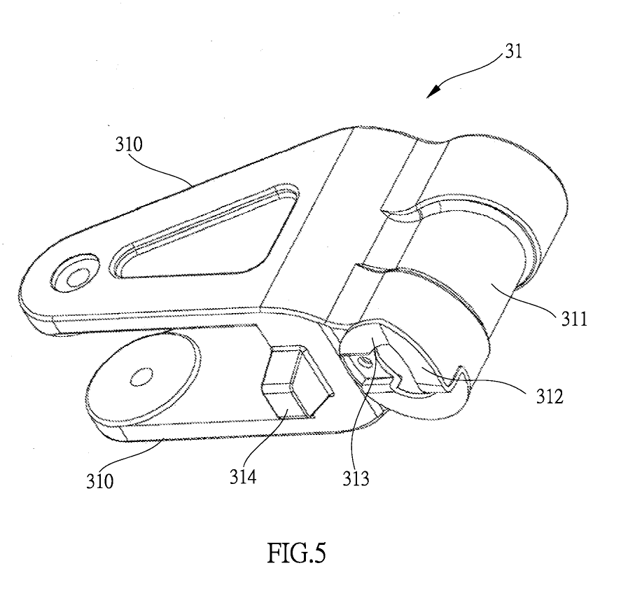

As best be seen in FIGS. 2 and 4, a coil spring 4 may be attached at one end to each leg portion 12 of the frame 1 with an upper hook 41, and at an opposite end to the sleeve bearing 311 of each wheel bracket 31 with a lower latch 42 so as to hold the wheel bracket 31 against the frame 1. With the spring 4, the tray 2 could be folded up with less force.

Furthermore, a protrusion 314 may be formed at a bottom of each wheel bracket 31, as best seen in FIG. 5, to be positioned in a cutout 27 (FIG. 2) that is defined in each pivot bracket 22 once the luggage carrier 100 is ready for use where the tray 2 is disposed in the forwardly extended position and the wheeled carriages 3 are in the rearwardly extended positions, as depicted in FIG. 6. This helps to stabilize the luggage carrier 100 when in use.

As described above, the left and right wheeled carriages 3 are pivotably mounted on the lower extremities of the lower leg portions 12 of the frame 1 in a relatively simple manner such that they automatically pivot to folded-in positions (FIG. 8) and rearwardly extended positions (FIG. 1 or 6) when the supporting tray 2 is moved between the folded-up position (FIG. 8) and the forwardly extended position (FIG. 1 or 6).

It is to be understood that the disclosed embodiments are illustrative in nature and the invention is not to be limited to any one or more embodiments except as set forth in the following claims.

What is claimed is:

1. A foldable luggage carrier, comprising:
a frame having an upper handle portion and a pair of lower leg portions configured to provide support for an article in a first plane;
a supporting tray having a pair of pivot brackets and two pivot pins; the pivot brackets receiving the pivot pins which transversely extending through lower ends of the leg portions of the frame such that the tray is pivotable between a forwardly extended position where the tray is disposed substantially orthogonally to the first plane, and a fold-up position where the tray is disposed substantially parallel with the first plane; wherein each of the pivot brackets includes a pair of opposed plates and at least one cam portion projecting from a corner of one of the plates; and
a pair of transversely spaced-apart wheeled carriages each having a wheel bracket and a wheel; each wheel bracket having two opposed projecting arms to embrace the wheel, and a sleeve bearing rotatably supported on each leg portion of the frame to permit the wheeled carriages to pivot between rearwardly extended positions where axes of rotation of the wheels are in parallel relation to the first plane, and folded-in positions where the axes of rotation of the wheels are disposed orthogonally to the first plane; wherein the sleeve bearing is formed at an annular bottom surface with a guiding slope section and a generally flat section which together define an obtuse angle therebetween;
wherein when the tray is disposed in the forwardly extended position, the cam portion of each pivot bracket is rested with one side in between the guiding slope section and the flat section of the respective sleeve bearing; and while the tray is moved from the forwardly extended position to the fold-up position, the cam portion swings about the pivot pin and bears against the guiding slope section of the sleeve bearing, resulting in each wheeled carriage pivoting from the rearwardly extended position to the folded-in position.

2. The foldable luggage carrier of claim 1, further comprising a spring attached at one end to each leg portion of the frame and at an opposite end to the sleeve bearing of each wheel bracket so as to hold the wheel bracket against the frame.

3. The foldable luggage carrier of claim 1, wherein the handle portion of the frame is a generally U-shaped telescoping handle.

4. The foldable luggage carrier of claim 1, wherein each of the wheel brackets is formed at a bottom with a protrusion to be positioned in a cutout defined in each pivot bracket when the tray is disposed in the forwardly extended position and the wheeled carriages are in the rearwardly extended positions.
